(19) United States
(12) Patent Application Publication
(10) Pub. No.: US 2024/0113787 A1
(43) Pub. Date: Apr. 4, 2024

(54) SIGNAL TRANSMISSION ASSEMBLY

(71) Applicant: SVT HOLDING S.P.A., Milano (IT)

(72) Inventor: Alessandro BAZZI, Milano (IT)

(21) Appl. No.: 18/276,289

(22) PCT Filed: Mar. 29, 2022
(86) PCT No.: PCT/IB2022/052886

§ 371 Date: Aug. 8, 2023

(30) Foreign Application Priority Data
Mar. 31, 2021 (IT) 102021000008009

(51) Int. Cl. H04B 10/40; G02B 6/42

(52) U.S. Cl. CPC H04B 10/40; G02B 6/4203

(57) ABSTRACT

A signal transmission assembly suitable for transmission of data, information, or power is provided. The signal transmission assembly has an axis, a central cavity, a first annular group and a second annular group at least partially facing along the axis and mutually rotationally movable with respect to the axis. The signal transmission assembly has signal transmission members having signal transmitting means included in the first annular group and signal receiving means included in the second annular group or vice versa. The signal transmitting means has an annular diffusing optical fiber element and at least one light emitter engaged with the annular diffusing optical fiber element suitable for emitting a light signal therein. The signal receiving means have at least one photodetector facing the annular diffusing optical fiber element.

The present invention relates to a signal transmission assembly.

In particular, the context in which the present invention is placed is that relating to signal transmission assemblies of the type comprising two groups that are rotationally movable with respect to each other, for example two groups that are mountable on two parts of a rotational joint, for example of a robotic arm, or more generally two groups that are mountable respectively on a rotor part and a stator part. In particular, preferably, the rotational movement of the rotor part with respect to the stator part is allowed in a continuous manner, with arbitrary values of the relative angle of rotation and also greater than the lap angle.

In further detail, the context in which the present invention is placed relates to signal transmission assemblies of the type comprising a central cavity or central cable passage. Preferably, within said central cavity or said hollow central passageway a portion of the rotor part extends, for example a rotating shaft, or cables or conduits or pipes extend.

In still further detail, the context in which the present invention is placed is that relating to signal transmission assemblies in which the two aforesaid groups are suitable for communicating with each other by contactless (i.e., contactless or wireless) transmission, i.e., using optical or photonic signal transmission techniques, avoiding the use of creeping contacts or, in general, solutions involving physical contact between the two parts.

With reference to the term “signal” or the term “signals” it should be noted that in the present discussion both “digital type signals” and “analog type signals” are intended generically. It is further pointed out that the term “signal” includes data and signals representing physical or abstract quantities, logical states, and their various combinations.

According to the present invention, without being limiting in any way, “signal” means, for example: communication with Ethernet protocol and derivatives, serial transmissions with RS232 RS422 RS485 standard and derivatives, SPI (Serial Peripheral Interface) and derivatives, i2c (Inter Integrated Circuit) and derivatives, digital communications with amplitude and/or phase modulation formats with an arbitrary number of digital transmission symbols, analog transmission with baseband signals and with carrier modulated in amplitude frequency or phase, digital packet transmissions.

In the state of the art, many embodiments of signal transmission assemblies belonging to the aforesaid specific context are known.

However, the well-known solutions of signal, cable, and data transmission modes with non-contact technology present a number of issues that have not always been resolved, or for which compromised choices have been necessary. For example, in the well-known solutions of signal transmission assemblies, a low efficiency is encountered, if compared with solutions wherein the transmission between the parts has a contact. For example, also the transmission of “power” is problematic and sometimes inaccurate, compromising the correctness of the data.

The object of the present invention is, therefore, to provide a cable signal and data transmission mode using non-contact technology, which is an effective and efficient alternative to currently known solutions by solving their specific technical problems.

Said object is achieved by a signal transmission assembly according to claim 1. The dependent claims relate to preferred variant embodiments having further advantageous aspects.

The object of the present invention is described in detail hereinafter, with the aid of the accompanying drawings, wherein:

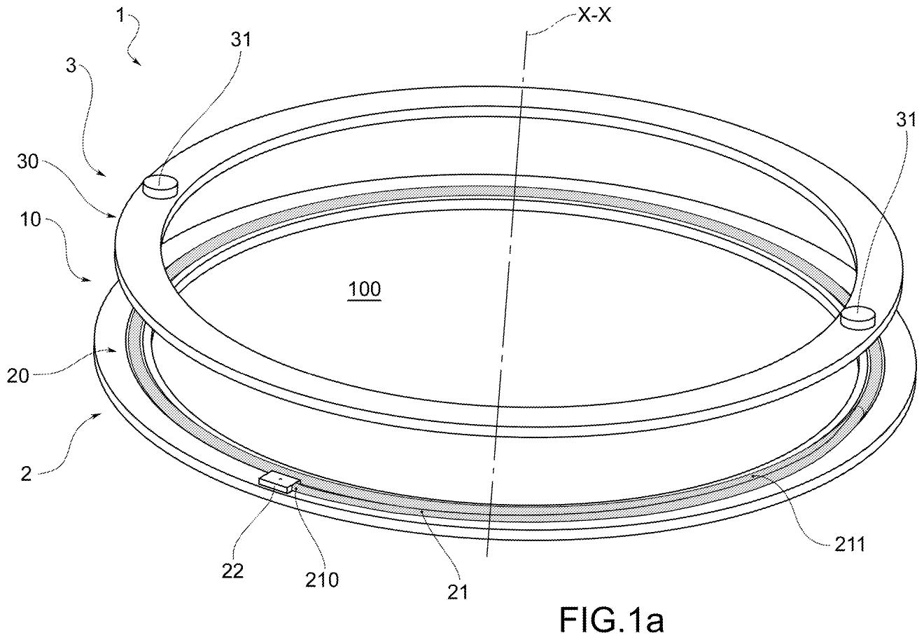

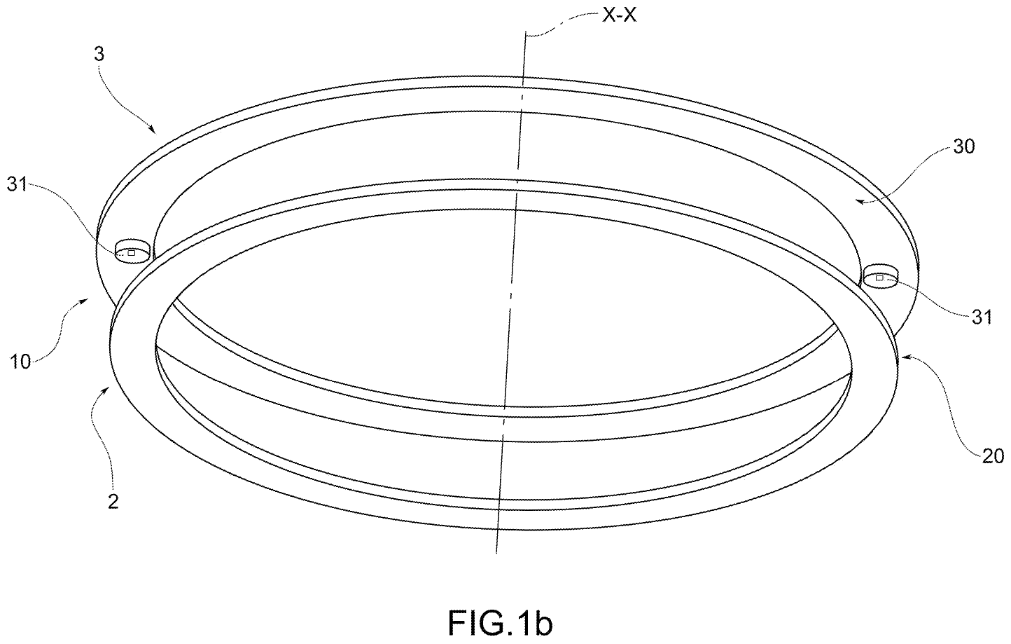

FIGS. 1a and 1b are two perspective views in separate parts of the signal transmission assembly according to the present invention;

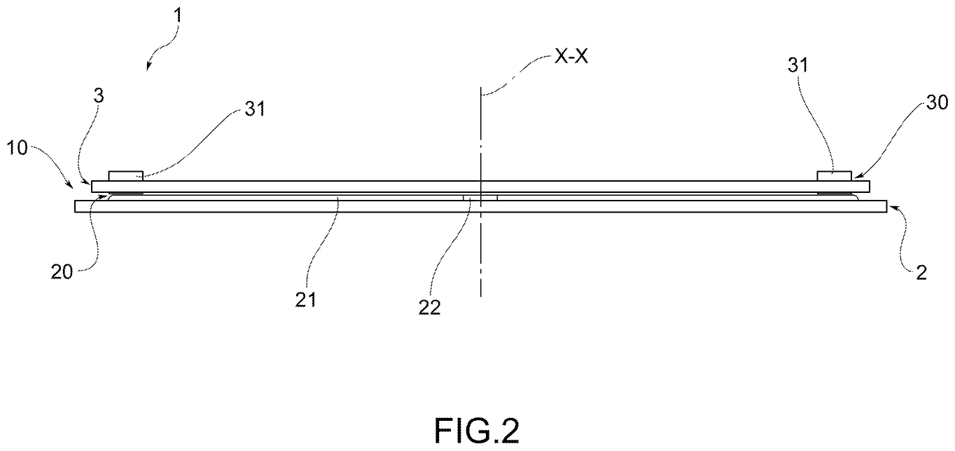

FIG. 2 is a side view of the signal transmission assembly in FIG. 1;

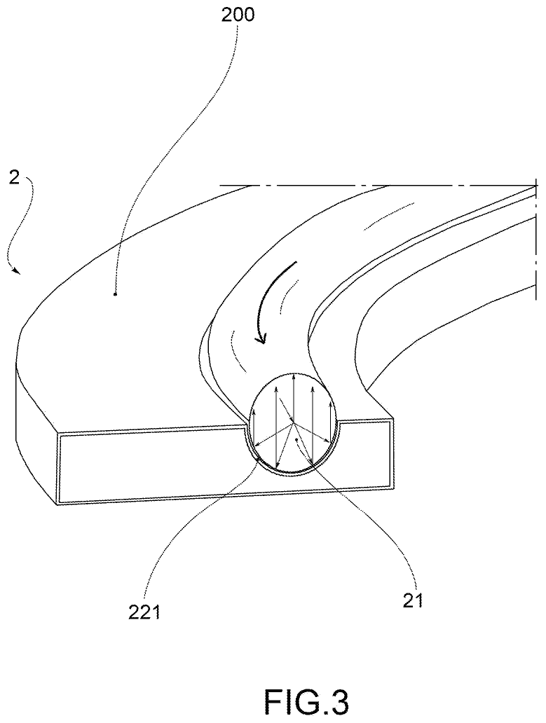

FIG. 3 is an enlarged cross-sectional view of the signal transmission assembly in FIG. 1;

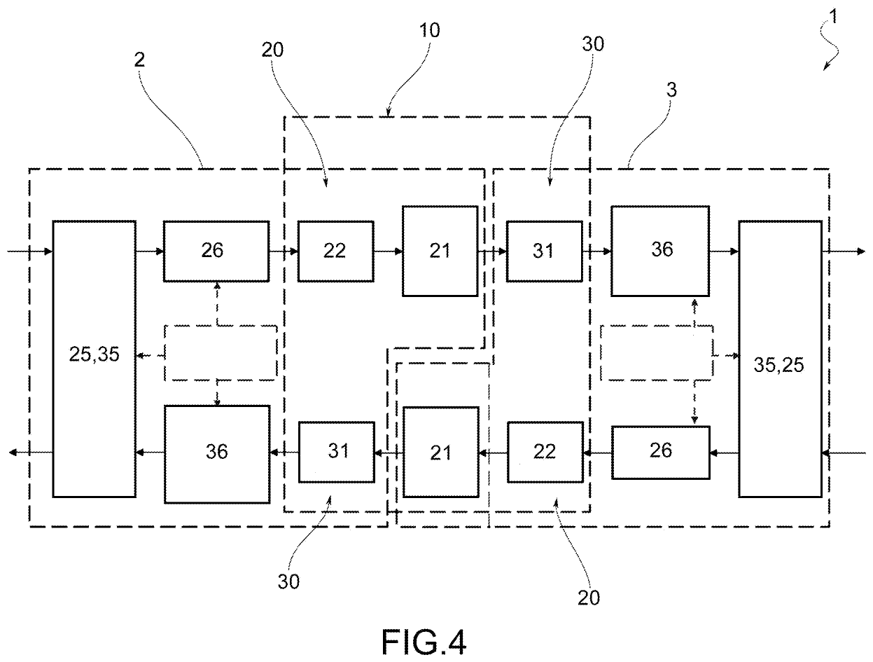

FIG. 4 is a schematic of a signal transmission assembly according to the present invention, wherein preferably, the signal transmission assembly is suitable for transmitting Ethernet data;

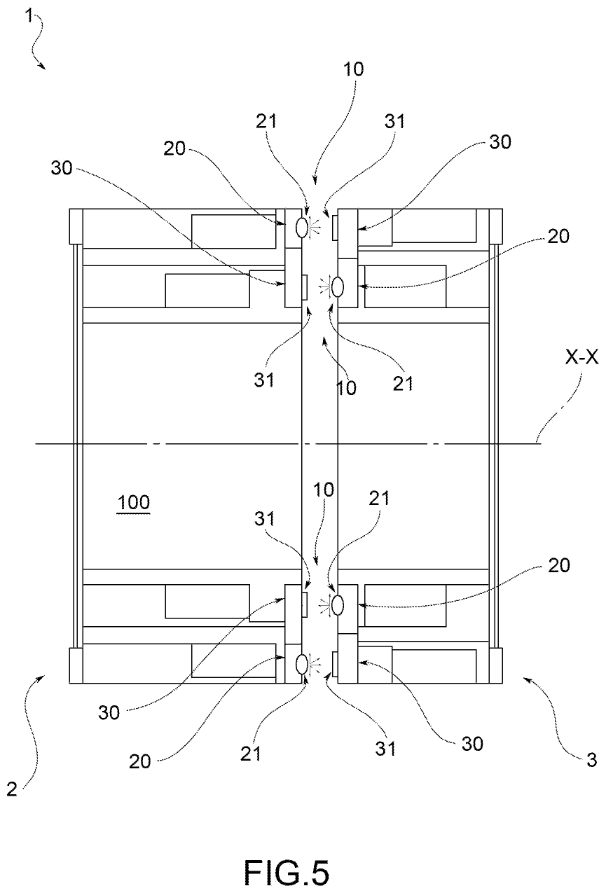

FIG. 5 is a schematic of an embodiment of a signal transmission assembly according to the present invention in accordance with a first embodiment;

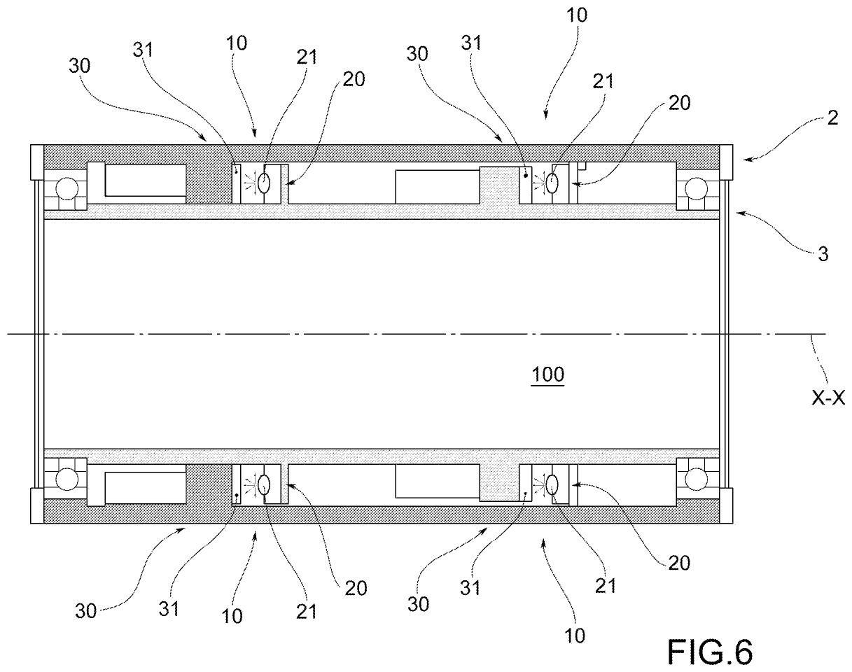

FIG. 6 is a schematic of an embodiment of a signal transmission assembly according to the present invention in accordance with a second embodiment.

In the above drawings, the reference numeral 1 denotes a signal transmission assembly in its entirety according to the present invention.

According to the invention, the signal transmission assembly 1 comprises an axis X-X. According to the present invention, the rotation of the components described below occurs with respect to said axis X-X.

In the present discussion, taking said axis X-X as a reference, it is specified that, with reference to an axial direction, a direction parallel to said axis X-X is indicated. Furthermore, with reference to said axis X-X, a radial direction, a circumferential direction, and a tangential direction are also defined. With reference to said axis X-X, an annular arrangement of one or more components of the signal transmission assembly 1 is defined preferably about said axis X-X along said circumferential direction.

The signal transmission assembly 1 has an axial extension direction parallel to said axis X-X.

The signal transmission assembly 1 further comprises a central cavity 100 along said axis X-X.

According to the present invention, a rotating shaft extends through said central cavity 100, or cables, conduits, pipes, etc. extend.

According to the present invention, the signal transmission assembly 1 further comprises a first annular group 2 and a second annular group 3.

Said first annular group 2 and said second annular group 3 are mutually at least partially facing each other along the axis X-X.

Furthermore, said first annular group 2 and said second annular group 3 are mutually movable in rotation with respect to the axis X-X. According to the present invention, the relative rotation between said first annular group 2 and said second annular group 3 is not angularly limited to specific imposed angles, being instead in free rotation about the axis X-X. Preferably, said first annular group 2 and said second annular group 3 are distinguishable as a stator part and a rotor part. Preferably, the first annular group 2 and the second annular group 3 are available or positionable on distinct components.

As per the subject matter of the present invention, the first annular group 2 and the second annular group 3 communicate and exchange data without mutual contact. Specifically, it is understood that the components described below with the specific object of transmitting and receiving a signal are not in contact. Also foreseeable are embodiments in which the first annular group 2 and the second annular group 3 have specific mechanical parts, such as special bearings, which are capable of ensuring the mutual rotational motion, placed in mutual contact.

In fact, the signal transmission assembly 1 comprises signal transmission members 10 comprising signal transmission means 20 comprised in the first annular group 2 and signal reception means 30 comprised in the second annular group 3.

In other words, in said embodiment, the signal transmission members 10 are suitable for communicating in one direction: from the first annular group 2 to the second annular group 3.

According to a preferred embodiment, the signal transmission assembly 1 comprises signal transmission members 10 comprising signal transmission means 20 comprised in the second annular group 3 and signal reception means 30 comprised in the first annular group 2. In other words, in said embodiment, the signal transmission members 10 are suitable for communicating in one direction: from the second annular group 3 to the first annular group 2.

In certain preferred embodiments, the signal transmission members 10 are such as to allow two-way communication, comprising pairs of signal transmission members 10, i.e., comprising first transmission means and first reception means and comprising second transmission means and second reception means.

According to a preferred embodiment, as shown schematically in the accompanying FIG. 5, the pair of signal transmission members 10 has radial development wherein the first signal transmission members 10 are proximal to the axis X-X, and the second signal transmission members 10 are radially distal from the axis X-X.

According to a further preferred embodiment, as shown schematically in the accompanying FIG. 6, the pair of signal transmission members 10 has axial development wherein the first signal transmission members 10 and the second signal transmission members 10 are arranged at the same distance from the axis X-X in two distinct axial positions.

According to the present invention, the signal transmission means 20 comprise an annular diffusing optical fiber element 21 and at least one light emitter 22 engaged to said annular diffusing optical fiber element 21 suitable for emitting a light signal therein. “Diffusing optical fiber” means that said optical fiber has diffusing properties, this diffusing optical fiber is also definable as natural diffusing optical fiber. In other words, “diffusing optical fiber” means an optical fiber that has a nanostructure or, in general molecular structure, suitable for performing diffusion. In other words, the diffusing optical fiber inherently has “scattering” properties, in still other words, the diffusing optical fiber does not require specific processing on its surface and/or does not need to be coupled to specific components or surfaces that perform said diffusion.

According to a preferred embodiment, the annular diffusing optical fiber element 21 extends circularly between two axial ends 210, 211.

Preferably, the two axial ends 210, 211 overlap by an angular segment. In this way, the annular ring is complete and it is certain that the annular diffusing optical fiber element 210, 211 extends and diffuses the light signal inside it for the entire 360°. In other words, the diffusing optical fiber 21 extends circularly beyond 360°; in a preferred embodiment, a diffusing optical fiber 21 extends also for more than one revolution.

According to a preferred embodiment, the light emitter 22 is engaged at an axial end 210 and emits the light signal within the annular diffusing optical fiber element 21 in the development direction of said annular diffusing optical fiber element 21. In other words, the light emitter 22 emits the light signal in a tangential direction, but it is transmitted in a circumferential direction along the annular diffusing optical fiber element 21. Said luminous signal is also diffused by the diffusing optical fiber element 21 in a direction orthogonal (i.e. radial) to the axis of development of the optical fiber itself.

According to a preferred embodiment, the annular diffusing optical fiber element 21 comprises a plurality of circularly aligned diffusing optical fiber arcs such that a ring is defined. Preferably, the signal transmission means 20 comprise a light emitter 22 suitable for emitting a light signal within a respective optical fiber arc.

According to a preferred embodiment, each optical fiber arc extends approximately 180°, comprising two optical fiber arcs for each annular diffusing optical fiber element 21. In a preferred embodiment, the light emitters 22 emit a light signal within a respective optical fiber arc in the same direction. In a further preferred embodiment, the light emitters 22 emit a light signal within a respective optical fiber arc in two opposite directions.

Further, according to a preferred embodiment, the first annular group 2 or the second annular group 3 housing the annular diffusing optical fiber element 21 comprises an annular groove 221 that contains a portion of the annular diffusing optical fiber element 21. Preferably, said annular groove 221 contains one half of the annular diffusing optical fiber element 21.

Preferably, the annular groove 221 has a semi-circular or polygonal cross section, for example rectangular.

According to a preferred embodiment, said annular groove 221 is covered with a coating having properties that are diffusive or reflective with respect to the light radiation emitted by the diffusing optical fiber. In other words, the surface of the annular groove 221 is suitable for receiving the signal diffused by the same diffusing optical fiber 21 to divert it in the direction of interest.

Preferably, said coating is a film.

Preferably, said annular groove 221 is suitable for directing the light signal in a preferred direction. For example preferably, the annular groove 221 is suitable for directing the light signal in an axial direction. For example, in further preferred embodiments, the annular groove 221 is suitable for directing the light signal in a radial direction.

According to a preferred embodiment, the signal receiving means 30 comprise at least one photodetector 31 facing the annular diffusing optical fiber element 21.

According to a preferred embodiment, the signal receiving means 30 comprise at least two angularly spaced photodetectors 31.

Preferably, the photodetectors 31 are positioned mutually angularly equidistant from each other.

According to a preferred embodiment, the signal receiving means 30 comprise at least four photodetectors 31, preferably angularly equidistant.

According to a preferred embodiment, the at least one photodetector 31 is positioned facing axially to the annular diffusing optical fiber element 21.

According to a preferred embodiment, the at least one photodetector 31 is positioned facing radially to the annular diffusing optical fiber element 21.

According to a preferred embodiment, the annular diffusing optical fiber elements 21 are of the type belonging to the family of special optical fibers suitable for guiding light radiation internally in a longitudinal direction, and at the same time continuously ensuring the diffusion of a fraction thereof outwardly in a radial and radial-longitudinal direction in an angularly continuous manner. As previously reported, diffusing optical fiber 21 means natural diffusing optical fiber and not optical fiber with waveguide.

According to a preferred embodiment, the annular diffusing optical fiber element 21 is of the type having a diameter of between 5 and 1000 μm, preferably between 50 and 1000 μm, preferably about 200 μm. According to a preferred embodiment, the annular diffusing optical fiber element 21 is of the single-mode fiber type. According to a preferred embodiment, the annular diffusing optical fiber element 21 is of the multi-mode fiber type.

According to a preferred embodiment, the light emitter 22 is of the type belonging to the family of semiconductor lasers or LEDs or superluminescent diodes, i.e., also known as SLEDs, or in a component suitable for emitting luminous, visible, or invisible electromagnetic radiation.

According to a preferred embodiment, the photodetector 31 is of the type belonging to the family of photodiodes, avalanche photodiodes, phototransistors, and photoresistence elements. According to a preferred embodiment, the photodetector 31 is a small device suitable for receiving light signals and converting them into electrical signals.

According to a preferred embodiment, the transmitted data is of the Ethernet type.

Preferably, the signal transmission means 20 comprise upstream of the light emitter 22 a transmission interface transceiver system 25 and a transmission driver group 26 suitable to drive the light emission from the light emitter 22. Preferably, the signal receiving means comprise, downstream of the photodetector 31, an amplification-conditioning group of the signal 36, and a transceiver receiving interface system 35.

In some preferred embodiments comprising two signal transmission members 10 and thus suitable for ensuring bidirectional data transmission and reception, the transmission interface transceiver system 25 and the reception interface transceiver system 35 are physically comprised in the same component, both operationally connected to the signal transmitting means 20 and the signal receiving means 30.

In other words, the signal transmission means 20 comprise, upstream of the light emitter 22, a bidirectional transmission interface transceiver system (for example, but not limited to, Ethernet type) and a driver group suitable for driving the light sources. In addition, the signal receiving means 30 comprise, downstream of the photodetector 31, a signal amplification or conditioning group and a bidirectional transceiver transmission interface system (for example, but not limited to, Ethernet type).

In certain embodiments comprising a pair of data or signal or power transmission members 10, the first group comprises both a receiving and a transmitting Ethernet transceiver, and likewise the second group comprises both a transmitting and a receiving Ethernet transceiver.

For example, said embodiments with bidirectional transmission-reception are shown in a schematic, non-limiting manner in FIG. 4.

According to a preferred embodiment, the signal transmission assembly 1 according to what is described above has the mutual rotation between the first annular group 2 and the second annular group 3 at a rotation speed proximal to 10000 rpm. In other words, data transmission is effective even at high rotational speeds.

Innovatively, the signal transmission assembly object of the present invention fully fulfills the intended object by overcoming the typical problems of the prior art.

Advantageously, the signal transmission assembly is reliable and enables efficient and effective transmission of data or signals or power.

Advantageously, the photodetectors are constantly facing the annular diffusing fiber element ensuring the quality and continuity of transmission.

Advantageously, the diffusing optical fiber ensures the emission of a high amount of transmitted optical power.

Advantageously, the diffusing optical fiber ensures a high value of signal-to-noise ratio for signal transmission.

Advantageously, in any mutual angular position of the first group with respect to the second group, the data or signals or power are transmitted correctly.

Advantageously, the use of a diffusing optical fiber, in particular, as said of a natural diffusing optical fiber, compared to solutions with waveguide optical fiber, simplifies both the diffusion action of the signal, and the production operations of the transmission assembly of the signal. Advantageously, it resolves the need for processing on the optical fiber. Advantageously, each point of the optical fiber diffuses the signal identically to the other.

Advantageously, an angle of rotation between the first group and the second group of arbitrary value, even greater than 360°, is allowed.

Advantageously, even solutions of large signal transmission assemblies, i.e., of large diameters, e.g., up to 500 mm, are feasible without affecting signal transmission, for example, by providing solutions wherein the annular optical fiber elements consist of a plurality of optical fiber arcs illuminated in parallel by specific light emitters.

Advantageously, the signal transmission assembly has a simple structure. Advantageously, the signal transmission assembly has low manufacturing and assembly costs.

Advantageously, the signal transmission assembly allows efficient and effective signal transmission in a single-directional manner, i.e., from one party to the other, but at the same time in a bidirectional manner, for example, in parallel full-duplex mode.

Advantageously, the signal transmission assembly allows signal transmission with full time continuity, even in parallel mode.

Advantageously, the diffusing optical fiber is positionable and possibly bendable as needed to define the trajectory and ring-shaped path. Advantageously, the natural diffusing optical fiber is positionable in the desired length and/or is adaptable to any support solution. Advantageously, the diffusing action of the diffusing optical fiber is not influenced by the nature, shape, or type of support wherein it is placed, it being intrinsically linked to said optical fiber.

Advantageously, the signal transmission assembly has electrical signals at its input and output.

Advantageously, the signal transmission assembly features an array of four chips, i.e., microprocessors, in cascade suitable for handling signal transmission with two chips, and signal reception with two other chips.

Advantageously, the signal transmission assembly is equipped with the internal cavity in which one or more components may be housed without affecting either the mutual rotation between the parts or the signal transmission.

It is clear that a person skilled in the art may make changes to the invention described above in order to meet incidental needs, all falling within the scope of protection as defined in the following claims.

1. A signal transmission assembly, comprising an axis and a central cavity extending along said axis, wherein the signal transmission assembly further comprises a first annular group and a second annular group;
wherein the first annular group and the second annular group at least partially face along the axis being mutually rotationally movable with respect to the axis;
wherein the signal transmission assembly further comprises signal transmission members comprising signal transmitting means comprised in the first annular group and signal receiving means comprised in the second annular group or vice versa;
wherein the signal transmitting means comprise an annular diffusing optical fiber element and at least one light emitter engaged with said annular diffusing optical fiber element suitable for emitting a light signal therein; and
wherein the signal receiving means comprise at least one photodetector facing the annular diffusing optical fiber element.

2. The signal transmission assembly of claim 1, wherein the signal receiving means comprise at least two angularly spaced, preferably angularly equally spaced, photodetectors.

3. The signal transmission assembly of claim 2, wherein the signal receiving means comprise at least four angularly equally spaced photodetectors.

4. The signal transmission assembly of claim 1, wherein the at least one photodetector is positioned axially facing the annular diffusing optical fiber element.

5. The signal transmission assembly of claim 1, wherein the at least one photodetector is positioned radially facing the annular diffusing optical fiber element.

6. The signal transmission assembly of claim 1, wherein the annular diffusing optical fiber element extends circularly between two axial ends, wherein the light emitter is engaged at one end of the two axial ends and emits the light signal within the annular diffusing optical fiber element in an extension direction of said annular diffusing optical fiber element.

7. The signal transmission assembly of claim 6, wherein the two axial ends overlap each other over an angular section.

8. The signal transmission assembly of claim 1, wherein the annular diffusing optical fiber element comprises a plurality of diffusing optical fiber arcs circularly aligned so as to identify a ring, and wherein the signal transmitting means comprise a light emitter suitable for emitting a light signal within a respective diffusing optical fiber arc.

9. The signal transmission assembly of claim 8, wherein the diffusing optical fiber arc extends about 180°.

10. The signal transmission assembly of claim 1, wherein the annular diffusing optical fiber element has a diameter between 50 and 1000 μm.

11. The signal transmission assembly of claim 1, wherein the first annular group or the second annular group houses the annular diffusing optical fiber element in an annular groove which contains at least half of the annular diffusing optical fiber element, wherein said annular groove is covered by a coating with diffusive or reflective properties with respect to a light radiation emitted by the annular diffusing optical fiber element.

12. The signal transmission assembly of claim 1, wherein the light emitter is one of a semiconductor laser, an LED, an SLD, or a component suitable for emitting visible or invisible electromagnetic light radiation.

13. The signal transmission assembly of claim 1, wherein the signal transmitting means comprise, upstream of the light emitter, a transmission interface transceiver system and a transmission driver unit suitable for driving light emission by the light emitter, and wherein the signal receiving means comprise, downstream of the at least one photodetector, a signal amplification-conditioning unit and a receiving interface transceiver system.

14. The signal transmission assembly of claim 1, comprising a pair of signal transmission members, wherein first signal transmission members comprise the signal transmitting means comprised in the first annular group and the signal receiving means comprised in the second annular group for transmitting data from the first annular group to the second annular group, and wherein second signal transmission members comprise the signal transmitting means comprised in the second annular group and the signal receiving means comprised in the first annular group, for the transmitting data from the second annular group to the first annular group.

15. The signal transmission assembly of claim 14, wherein the pair of signal transmission members has radial extension, wherein the first signal transmission members are proximal to the axis and the second signal transmission members are radially distal from the axis, so that the first signal transmission members comprise the signal transmitting means and the signal receiving means positioned at a first radial distance from the axis, and the second signal transmission members comprise auxiliary signal transmitting means and auxiliary signal receiving means positioned at a second radial distance from the axis.

16. The signal transmission assembly of claim 15, wherein the signal transmission members axially extend comprising the signal transmitting means and the signal receiving means positioned at a first axial position with respect to the axis and the auxiliary signal transmitting means and the auxiliary signal receiving means positioned at a second axial position with respect to the axis.

17. The signal transmission assembly of claim 1, wherein a mutual rotation between the first annular group and the second annular group achieves a rotational speed proximal to 10000 rpm.

18. The signal transmission assembly of claim 1, wherein the first annular group and the second annular group comprise a central cavity having a diameter between 10 mm and 5000 mm.

19. The signal transmission assembly of claim 1, wherein the signal transmission assembly is suitable for transmission of data, information, or power.

20. The signal transmission assembly of claim 11, wherein the annular groove has a semi-circular or polygonal cross section, for example rectangular.
